(19) United States
(12) Patent Application Publication
(10) Pub. No.: US 2013/0146037 A1
(43) Pub. Date: Jun. 13, 2013

(54) MILLER CYCLE ENGINE SYSTEM AND CONTROL METHOD THEREOF

(71) Applicants: Dong Hee Han, Seoul (KR); Jae Young Jeun, Seoul (KR); Hong Jip Kim, Hwaseong-si (KR); Seung Kook Han, Suwon-si (KR); Hyuk Im, Suwon-si (KR)

(72) Inventors: Dong Hee Han, Seoul (KR); Jae Young Jeun, Seoul (KR); Hong Jip Kim, Hwaseong-si (KR); Seung Kook Han, Suwon-si (KR); Hyuk Im, Suwon-si (KR)

(73) Assignee: Hyundai Motor Company, Seoul (KR)

(21) Appl. No.: 13/472,186

(22) Filed: May 15, 2012

(30) Foreign Application Priority Data
Dec. 7, 2011 (KR) 10-2011-0129994

(51) Int. Cl. F02B 33/00

(52) U.S. Cl. 123/565

(57) ABSTRACT

A miller cycle engine system is provided, which includes a motorized supercharger, and a miller cycle engine (having low compression and high explosion) having the motorized supercharger mounted thereon to improve a low-revolution performance of an engine using a scavenging phenomenon due to an operation of a variable valve device (variable valve timing, variable valve lift and variable valve duration) during an operation of the motorized supercharger and to improve a fuel efficiency through down-speeding of a gear ratio of a vehicle.

### CROSS-REFERENCE TO RELATED APPLICATION

The present application claims priority of Korean Patent Application Number 10-2011-0129994 filed Dec. 7, 2011, the entire contents of which application is incorporated herein for all purposes by this reference.

### BACKGROUND OF INVENTION

1. Field of Invention

The present invention relates to a miller cycle engine system and a control method thereof, and more particularly, to a miller cycle engine system and a control method thereof, which can improve engine performance and fuel efficiency through adoption of a miller cycle engine using a motorized supercharger.

2. Description of Related Art

In general, according to a typical vehicle, outside air flows into an engine room, the inflow air and fuel are mixed in an appropriate ratio, and the air-fuel mixture is combusted in an engine.

Techniques for further improving the operation efficiency of an engine have been disclosed.

Atkinson engine is an engine in which the size of the intake stroke of the internal combustion engine is different from the size of the explosion stroke. According to this Atkinson engine, since the explosion stroke is maintained to be larger than the intake stroke and the cylinder pressure, which is higher than the atmospheric pressure during the initial exhaust stroke, is extracted as a work, the fuel efficiency improvement effect of about 10% can be obtained.

In order to improve the operation performance according to the operation conditions of the engine, a continuously variable valve timing (CVVT) device is used. The continuous variable valve timing device improves the performance of the engine through adjustment of the opening and closing time of an intake valve and an exhaust valve by means of hydraulic pressure that is generated in an oil pump while the engine operates.

In order to obtain a desired output and combustion efficiency of the engine in the process of generating power through driving of the engine, it is required to supply a sufficient amount of outside air, and there is a supercharger as a device for supplying air for combustion to heighten the combustion efficiency of the engine.

The supercharger compresses air through rotation of a fan using the power of the engine and supplies the compressed air.

Here, according to a typical mechanical supercharger that operates through reception of the power of the engine, if the revolution of the engine is high, the supercharger receives sufficient rotating force and properly compresses the air, whereas if the revolution of the engine is intermediate or low, the supercharger receives non-sufficient rotating force and the compression degree thereof is decreased to lower the operation improvement effect of the engine.

In the case of using the existing mechanical supercharger in an engine to which the Atkinson engine or the continuously variable valve timing (CVVT) device is applied, the existing mechanical supercharger merely operates through reception of the rotating force of the engine, and thus it is not possible to maximize the characteristic utilization of the Atkinson engine, in which the sizes of the intake stroke and the explosion stroke differ from each other, or the continuously variable valve timing device, in which the operation state of the exhaust value differs through adjustment of the valve opening/closing time.

The information disclosed in this Background section is only for enhancement of understanding of the general background of the invention and should not be taken as an acknowledgement or any form of suggestion that this information forms the prior art already known to a person skilled in the art.

### SUMMARY OF INVENTION

Accordingly, the present invention has been made to solve the above-mentioned problems occurring in the prior art while advantages achieved by the prior art are maintained intact.

Various aspects of the present invention provide for a miller cycle engine system adopting a motorized supercharger device and method for a vehicle, which can operate a supercharger on optimum conditions that correspond to the characteristic and operation of an Atkinson cycle engine through connection of a motor, which rotates to correspond to driver's torque requirements, to a driving shaft of the supercharger of the vehicle.

Various aspects of the present invention provide for a miller cycle engine system adopting a motorized supercharger device and method for a vehicle, which can enable a supercharger to be operated by a motor that operates to correspond to driver's torque requirements even in the situation where the revolution of the engine is low, and thus can improve the operation efficiency and fuel efficiency during low-speed operation of the engine.

Various aspects of the present invention provide for a miller cycle engine system, which includes a motorized supercharger; and a miller cycle engine (having low compression and high explosion) having the motorized supercharger mounted thereon to improve a low-revolution performance of an engine using a scavenging phenomenon due to an operation of a variable valve device (variable valve timing, variable valve lift and variable valve duration) during an operation of the motorized supercharger and to improve a fuel efficiency through down-speeding of a gear ratio of a vehicle.

The motorized supercharger may be driven by electric power of a battery.

The miller cycle engine may include an air cleaner supplying air to the motorized supercharger; an intercooler cooling the air compressed by the motorized supercharger and supplying the cooled air to the engine; a bypass valve controlling air flow so that the compressed air flows into the engine and is prevented from flowing backward to the air cleaner during an operation of the supercharger, or the compressed air flows backward to prevent noise occurrence during an operation of a throttle; an intake cam controlling intake of an air-fuel mixture to the engine; an exhaust cam controlling exhaust of combustion gas from the engine; a motor providing power that is necessary for air compression of the motorized supercharger; a battery providing electric power to the motor; an engine revolution sensor checking the revolution of the engine; an acceleration pedal sensor checking a degree of driver's acceleration pedal operation; and a control unit controlling operations of the intake cam, the exhaust cam, and the motor according to output values of the engine revolution sensor and the acceleration pedal sensor.

Various aspects of the present invention provide for a method of controlling a miller cycle engine system, which includes checking an engine operation state; increasing a driver's required torque through a driver's acceleration pedal operation; operating a motorized supercharger if the driver's required torque is higher than the performance of an Atkinson engine; operating an intake cam and an exhaust cam if the driver's required torque is higher than the performance before a variable valve device (variable valve timing, variable valve lift and variable valve duration) operates; making the driver's required torque coincide with an actual vehicle speed through development of a miller cycle with the operation of the intake cam and the exhaust cam; and turning off the motorized supercharger if the driver's required torque is released during a normal-speed or reduced-speed operation of the engine.

The step of making the driver's required torque coincide with an actual vehicle speed may advance the intake cam and delay the exhaust cam to maximize the performance of the motorized supercharger.

In the step of checking an engine operation state, the engine operation state may include an idle state and a normal-speed operation state.

As described above, according to the present invention, the supercharger of the vehicle can be operated on the optimum conditions that correspond to the characteristic and operation of the Atkinson cycle engine or the engine that adopts the continuously variable valve timing device through connection of the motor, which rotates to correspond to the driver's required torque, to the driving shaft of the supercharger, and thus the engine operation efficiency can be improved.

Further, the motorized supercharger is operated by the motor that operates to correspond to the driver's required torque even in the situation where the revolution of the engine is low, and thus the operation efficiency and fuel efficiency during the low-speed operation of the engine can be improved.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a block diagram illustrating the configuration of an exemplary miller cycle engine system according to the present invention.

FIG. 2 is a flowchart illustrating an exemplary method of controlling a miller cycle engine system according to the present invention.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

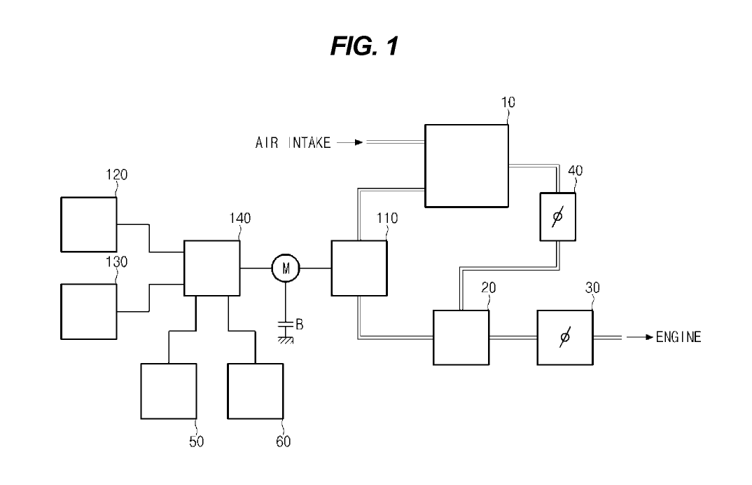

Referring to FIG. 1, a miller cycle engine system according to various embodiments of the present invention includes an intercooler 20, a bypass valve 40, an intake cam 50, an exhaust cam 60, a motor M, a battery B, a motorized supercharger 110, an engine revolution sensor 120, an acceleration pedal sensor 130, and a control unit 140.

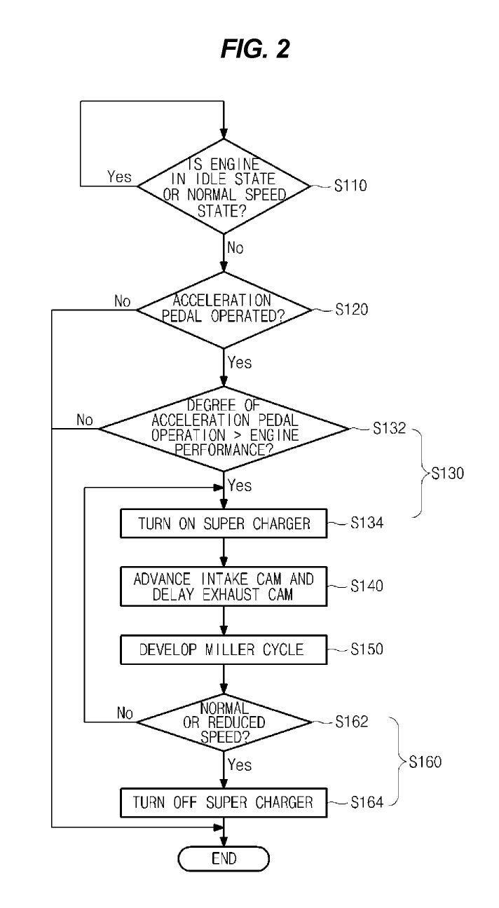

Referring to FIG. 2, a method of controlling a miller cycle engine system according to various embodiments of the present invention includes checking an engine operation state (S110), checking an acceleration pedal state (S120), operating a motorized supercharger (S130), checking the performance before a variable valve device (variable valve timing, variable valve lift and variable valve duration) (S140), developing a miller cycle (S150), and turning off the motorized supercharger (S160).

Referring to FIGS. 1 and 2, the configuration and operation of the present invention will be described.

The motorized miller cycle engine system according to various embodiments of the present invention includes a motorized supercharger 110, and a miller cycle engine (having low compression and high explosion) having the motorized supercharger 110 mounted thereon to improve a low-revolution performance of an engine using a scavenging phenomenon due to an operation of a variable valve device (variable valve timing, variable valve lift and variable valve duration) during an operation of the motorized supercharger 110 and to improve a fuel efficiency through down-speeding of a gear ratio of a vehicle.

That is, according to the motorized miller cycle engine system according to various embodiments of the present invention, the motorized supercharger 110 is mounted on the miller cycle engine to improve the low-speed torque through the operation of the supercharger 110, a miller cycle is developed to improve the self-efficiency of the engine, and thus the fuel efficiency is improved.

Hereinafter, configuration elements of the motorized miller cycle engine system according to various embodiments of the present invention will be described.

Hereinafter, the configuration elements of the motorized miller cycle engine system will be described.

The motorized supercharger 110 compresses air flowing from outside, and supplies the compressed air to the engine through an intake cam 50.

That is, the air flowing from the outside through an air duct is purified through an air cleaner 10, is pressed by the motorized supercharger 110, and is cooled through the intercooler 20 to flow into the engine through a throttle body 30. At this time, the supplied air is mixed with fuel as an air-fuel mixture, and is supplied to a combustion chamber of the engine through an intake cam 50 to be combusted. The combustion gas generated due to the combustion in the combustion chamber is discharged to outside through an exhaust cam 60.

The miller cycle engine (having low compression and high explosion) includes an air cleaner supplying air to the motorized supercharger, an intercooler cooling the air compressed by the motorized supercharger and supplying the cooled air to the engine, a bypass valve controlling air flow so that the compressed air flows into the engine and is prevented from flowing backward to the air cleaner during an operation of the supercharger or the compressed air flows backward to prevent noise occurrence during an operation of a throttle, an intake cam controlling intake of an air-fuel mixture to the engine, an exhaust cam controlling exhaust of combustion gas from the engine, a motor M providing power that is necessary for air compression of the motorized supercharger, a battery B providing electric power to the motor, an engine revolution sensor checking the revolution of the engine, an acceleration pedal sensor checking a degree of driver's acceleration pedal operation, and a control unit controlling operations of the intake cam, the exhaust cam, and the motor M according to output values of the engine revolution sensor and the acceleration pedal sensor.

Here, the throttle body 30 adjusts the amount of air flowing into the engine. At this time, if a throttle valve is closed by a driver's operation, the air, which is purified by the air cleaner 10 and pressed by the motorized supercharger 110, is unable to be supplied to the engine through the throttle body 30, and flows backward to the motorized supercharger 110 and the intercooler 20. At this time, noise may occur as the backward air strikes a blade of the motorized supercharger 110. However, according to the configuration in which a front end of the intercooler 20 and a rear end of the air cleaner (air inlet side of the air cleaner) 10 are connected through a connection pipe and the bypass valve 40 is formed in the middle of the connection pipe, when the throttle valve is closed, the bypass valve 40 is opened to prevent the backward air from entering into a surge area of the supercharger and to prevent the noise occurrence.

The operation of the main configuration elements according to various embodiments of the present invention will be described.

If the driver starts the engine to drive the vehicle, the engine operation state is checked by the engine revolution sensor 120 (S110). Then, a signal that corresponds to the measured value is output from the engine revolution sensor 120.

The control unit 140 receives the signal output from the engine revolution sensor 120, checks the engine operation state, and outputs a control signal that corresponds to the engine operation state (S110).

If the engine revolution is kept constant (engine idle operation state or a vehicle normal traveling state), the control unit 140 does not perform separate control, and keeps a typical engine operation state with no help.

If the driver operates an acceleration pedal after starting the vehicle engine, the acceleration pedal sensor 130 measures the operation degree of the acceleration pedal, and outputs a signal that corresponds to the measured value (S120).

Here, the operation of the acceleration pedal means requirement of a predetermined torque through the driver's engine operation. Accordingly, the operation degree of the acceleration pedal corresponds to the degree of driver's required torque.

The signal output from the acceleration pedal sensor 130 is input to the control unit 140.

The control unit 140 checks the acceleration pedal operation degree according to the signal input from the acceleration pedal sensor 130, and turns on the operation of the motorized supercharger 110 according to the result of the checking (S130).

First, according to the input signal from the acceleration pedal sensor 130, the control unit 140 determines whether or not the torque required by the driver is larger than the torque that can be obtained in a typical engine operation state (S132). If the required torque is larger than the torque that can be obtained in a typical engine operation state, the control unit 140 outputs a motor control signal to operate a motor M connected to the motorized supercharger. The motor M operates to turn on the operation of the motorized supercharger 110 (S134).

The control unit 140 outputs the motor control signal to operate the motor M with the revolution that corresponds to the driver's required torque. Further, the control unit 140 controls the operation of the motor M in consideration of the engine revolution in addition to the driver's required torque.

The motor M provides a driving force that is required to operate the motorized supercharger 110. The motor M receives power that is supplied from a battery B. Here, in the battery B, the output power of a generator that is connected to the vehicle engine is charged. It is preferable that the vehicle generator has a rated output.

Further, if it is determined that the driver's required torque is larger than the torque that can be obtained in a typical engine operation state, it is preferable to maximize a scavenging effect (S140) through advancing of the intake cam 50 and delaying of the exhaust cam 60 (S136) to increase overlapping.

Then, during the compression after the intake, a miller cycle that delays the time until the intake valve is closed is developed to improve the fuel efficiency (S150).

Here, the advancing of the intake cam 50 and the delay of the exhaust cam 60 are controlled by the control unit 140. That is, the control unit 140 controls the operation state of the intake cam 50 and the exhaust cam 60 through control of a hydraulic circuit that controls the operation of the intake cam 50 and the exhaust cam 60.

As described above, by maximizing the scavenging effect, the performance of the motorized supercharger 110 can also be maximized.

As the driver's required torque is obtained through the operation of the motorized supercharger 110, the vehicle speed is increased to a predetermined speed.

Thereafter, if the vehicle speed is decreased through the operation of the vehicle engine, the motorized supercharger 110 is stopped.

That is, if it is checked that the engine is in a normal traveling state (S162), the control unit 140 stops the operation of the motor M, and turns off the operation of the motorized supercharger 110 (S164).

As described above, in the case where the driver operates the acceleration pedal to obtain a predetermined torque in an engine idle state, the motorized supercharger is operated by the motor, and thus the vehicle speed required by the driver can be easily obtained. Further, even in the case of the low-speed operation of the engine, the supercharger can be efficiently operated to improve the fuel efficiency of the vehicle.

Further, by applying the present invention to the Atkinson cycle engine and/or the engine that adopts the continuously variable valve timing device, an optimum super charging effect that matches the characteristic of the engine can be obtained.

For convenience in explanation and accurate definition in the appended claims, the terms upper or lower, front or rear, inside or outside, and etc. are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A miller cycle engine system comprising:
a motorized supercharger; and
a miller cycle engine having the motorized supercharger mounted thereon to improve low-revolution performance of an engine using a scavenging phenomenon due to an operation of a variable valve device (variable valve timing, variable valve lift and variable valve duration) during an operation of the motorized supercharger and to improve a fuel efficiency through down-speeding of a gear ratio of a vehicle.

2. The miller cycle engine system according to claim 1, wherein the motorized supercharger is driven by electric power of a battery.

3. The miller cycle engine system according to claim 1, wherein the miller cycle engine comprises:
an air cleaner supplying air to the motorized supercharger;
an intercooler cooling the air compressed by the motorized supercharger and supplying the cooled air to the engine;
a bypass valve controlling air flow so that the compressed air flows into the engine and is prevented from flowing backward to the air cleaner during an operation of the supercharger, or the compressed air flows backward to prevent noise occurrence during an operation of a throttle;
an intake cam controlling intake of an air-fuel mixture to the engine;
an exhaust cam controlling exhaust of combustion gas from the engine;
a motor providing power for air compression by the motorized supercharger;
a battery providing electric power to the motor;
an engine revolution sensor checking the revolution of the engine;
an acceleration pedal sensor checking a degree of driver's acceleration pedal operation; and
a control unit controlling operations of the intake cam, the exhaust cam, and the motor according to output values of the engine revolution sensor and the acceleration pedal sensor.

4. A method of controlling a miller cycle engine system, comprising:
checking an engine operation state;
increasing a driver's required torque through a driver's acceleration pedal operation;
operating a motorized supercharger if the driver's required torque is higher than the performance of an Atkinson engine;
operating an intake cam and an exhaust cam if the driver's required torque is higher than the performance before a variable valve device (variable valve timing, variable valve lift and variable valve duration) operates;
making the driver's required torque coincide with an actual vehicle speed through development of a miller cycle with the operation of the intake cam and the exhaust cam; and
turning off the motorized supercharger if the driver's required torque is released during a normal-speed or reduced-speed operation of the engine.

5. The method of controlling a miller cycle engine system according to claim 4, wherein the step of making the driver's required torque coincide with an actual vehicle speed advances the intake cam and delays the exhaust cam to maximize the performance of the motorized supercharger.

6. The method of controlling a miller cycle engine system according to claim 4, wherein in the step of checking an engine operation state, the engine operation state includes an idle state and a normal-speed operation state.
